(19) United States
(12) Patent Application Publication
(10) Pub. No.: US 2007/0122536 A1
(43) Pub. Date: May 31, 2007

(54) Method for the production of food products having reduced fat content

(75) Inventors: Catherine Fryirs, Enfield (AU); Kathy Haigh, Normanhurst (AU)

Correspondence Address: SUGHRUE MION, PLLC, 2100 PENNSYLVANIA AVENUE, N.W., SUITE 800, WASHINGTON, DC, 20037, US

(73) Assignee: GEORGE WESTON FOODS LIMITED, Chatswood, New South Wales (AU)

(21) Appl. No.: 10/565,670

(22) PCT Filed: Jul. 23, 2004
(86) PCT No.: PCT/AU04/00988

§ 371 Date: Jan. 18, 2007

(30) Foreign Application Priority Data
Jul. 25, 2003 (AU) 2003903852

(51) Int. Cl. A21D 10/00

(52) U.S. Cl. 426/549

(57) ABSTRACT

Methods for the production of food products comprising wheat and/or rye flour and added fat, said method comprising substituting the flour with 0.5-100% w/w of waxy wheat flour, wherein said waxy wheat flour replaces fat content in said food product by 20-100% w/w are described. Also described is use of waxy wheat in the preparation of a food product with a reduced fat content.

This invention relates to methods for the production of food products having reduced fat content, such as reduced levels of shortening and/or oils or other fats. In another aspect this invention is concerned with food products having reduced levels of fat content. In still further aspects this invention is concerned with puffed snacks produced by baking, frying or microwaving half products; and instant noodle snacks, together with methods for their production.

Baked goods are typically prepared from wheat flour and fats and contain, for example, from 5 to 30% fat such as shortening, which contains monoglycerides and diglycerides, and/or oil. The fat content provides a characteristic soft eating quality/texture, and maintenance of shelf life for an extended time period.

Hamburger buns are typically prepared from hard wheat flour and high levels (5 to 15%) of shortening and/or oil, and high sugar levels. The high levels of fat and sugar in hamburger buns and other breads are undesirable from a nutritional viewpoint. However, consumers are generally unwilling to sacrifice taste for nutrition.

Cakes are typically prepared from soft wheat flour and high levels (from about 10 to about 30%) of shortening and/or oil. Cakes are not generally viewed as nutritious due to their high fat and sugar content.

Puffed pastry is prepared from hard wheat flour and shortening (for example butter), generally in equal amounts. Quality is determined by expansion and lamination, which is attributed to at least some extent to the high fat content. Nutritionally, such high fat pastry products are undesirable.

U.S. Pat. No. 6,042,867 describes flour blends for the production of breads, cakes or noodles, which contain various proportions of waxy wheat flour, and other food products formed from said waxy wheat. In the case of bread, the waxy wheat flour content is 0.5 to 30%. Additionally, the breads contain fats and oils, for example, 13% shortening oil.

With regard to cakes, a waxy wheat flour content between 1 and 30% is described, together with a content of as much as 90% shortening, such as margarine or butter.

International Patent publication No. WO 200149131 describes a method of producing waxy grain products which remains stable without the addition of substances that inhibit rancidity. Edible fats or oils are used to give rise to a food product.

There remains a need for food products which have low fat content, whilst at the same time maintaining eating quality and texture/appearance.

Various baked products containing gums, combination of proteins and gums, and other fat substitutes, have been used in attempts to provide low fat products. However, such additives are expensive, are not suitable in foods which utilise high levels of fat for taste and texture, and may alter product appearance.

It has surprisingly been found by the applicant that a waxy flour product, for example, waxy wheat flour can replace fat content in food products, such as baked goods either partially or completely, without loss of taste, eating quality, texture or appearance of said food product.

### SUMMARY OF THE INVENTION

The present inventors carried out a series of studies in an attempt to solve the problem of reducing fat content of food products, particularly baked goods such as hamburger buns, cakes and pastry whilst maintaining these products' characteristic eating qualities and textures. It was found by the applicant that the using waxy wheat flour the fat content of baked food products could be replaced, by 20-100% w/w, such as 30 to 80%w/w, including 30-40%, 30-50%, 30-60% and 30-75%w/w. The extent of fat replacement is significant and may vary depending on the relevant embodiment.

The inventors have found that foods such as hamburger buns and cakes prepared from a flour blend prepared from waxy wheat flour provide excellent texture and eating quality and improve nutrition quality of the product. This texture was traditionally provided by fat and sugar in hamburger buns and cakes. However, it has been found by the inventors that waxy flour contributes to the texture to provide a product with a texture, which is comparable or may even better than corresponding products containing fat. In the case of pastry prepared from waxy wheat flour, the product showed improved expansion and lift, in the absence of added fat. The latter is particularly true for croissants according to the invention, which have 30% less fat but the same desirable “fluffy” texture.

Another embodiment of the invention, for example in hamburger buns and the like, has the further advantage that the amount of sugar used in the product can also be significantly reduced in comparison to the level traditionally employed, thereby allowing the preparation of a “healthier” more desirable food product. The sugar content may be reduced by 20% or more such 20%-30%, 25%-35%, 30%-40%, 35%-45% and 40%-50% by weight.

In further studies carried out to produce nutritious baked snacks or foods, containing low, lower or no fat and excellent qualities and textures, the present inventors have surprisingly found that ready to consume snack foods can be prepared using waxy wheat flour without any fat addition.

In accordance with the broadest aspect of this invention there is provided a method for the production of food products comprising wheat, rice, corn, sorghum, mung bean, tapioca, soya, rye flour and/or and any other flour and added fat, said method comprising substituting the flour with 0.5-100% w/w of waxy wheat flour, wherein said waxy wheat flour replaces the fat content in said food product by 20-100% w/w.

Generally the food products are selected from bread, rolls, pizza bases, tortillas, spring roll pastry, buns such as hamburger buns, cake, muffins, pastry such as croissants, brioche or Chinese buns, pastry products such as pies, and tarts, puffed snacks, and noodles particularly ready to eat noodle snacks, biscuits and wafers wherein waxy wheat flour in said products replaces the fat content.

Preferably the baked food product is a bakery item such as bread, rolls, buns such as hamburger buns, cake, pastry such as croissants or brioche, pastry products such as pies, and tarts, puffed snacks, and ready to eat noodle snacks wherein waxy wheat flour in said products replaces fat content.

Extruded half products in the context of this specification will be understood to mean an extruded product of reduced thickness, for example, 0.5-5 mm which is subjected to further processing such as baking, frying, microwaving or the like to give an edible food product.

In accordance with a further aspect of this invention there is provided a method for the production of a food product comprising the steps of:
(a) mixing waxy wheat flour, or a blend of waxy wheat flour and wheat flour, with 30-75 such as 40 to 60 parts of water to form a dough or batter;
(b) resting the dough or batter at about 15-30° C. for 1 minute to about 2 hours; and
(c) reducing the thickness of the dough to about 0.5 to 5 mm such as 1.5 to 3 mm, cutting said dough into a plurality of pieces and subjecting the dough to drying or steaming and/or microwaving, steaming and/or baking or steaming and/or flying or
(d) spreading a thin layer of dough or batter onto a heated plate at about 180° C. to 220° C. for about 80-140 seconds to give an expanded wafer.

In another aspect preferably the method is for the production of a ready to consume snack food product comprising the steps of:
(a) mixing 100 parts of waxy wheat flour, or a blend of waxy wheat flour and wheat flour comprising at least 50% waxy wheat flour, with 30-75 such as 40 to 60 parts water to form a dough;
(b) resting the dough at 15-30° C. for 1 minute to about 2 hours; and
(c) reducing the thickness of the dough to about 0.5 to 5 mm such as 1.5-3 mm, cutting the dough to a thickness between about 1.5-3 mm into a plurality of snack pieces, and contacting the snack pieces with steam for about 2-3.5 minutes and/or baking the snack pieces at 130-190° C. for about 3-9 minutes, so as to give an expanded, high gloss snack food product; or
(d) spreading a thin layer of dough onto a heated plate at 180° C. to 220° C. for 80-140 seconds to give an expanded wafer.

The invention also extends to use of waxy wheat in the preparation of a food product, particularly a bakery product such as a hamburger bun or a noodle product with reduced a fat content.

### A BRIEF DESCRIPTION OF THE FIGURES

FIG. 1a shows a perspective view of a puffed snack made from non-waxy wheat flour.

FIG. 2a shows a perspective view of a puffed snack made from waxy wheat flour.

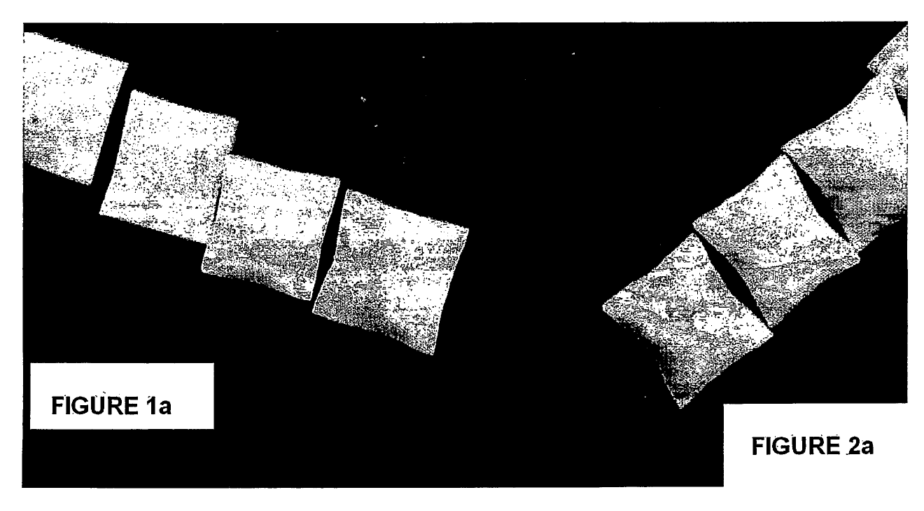

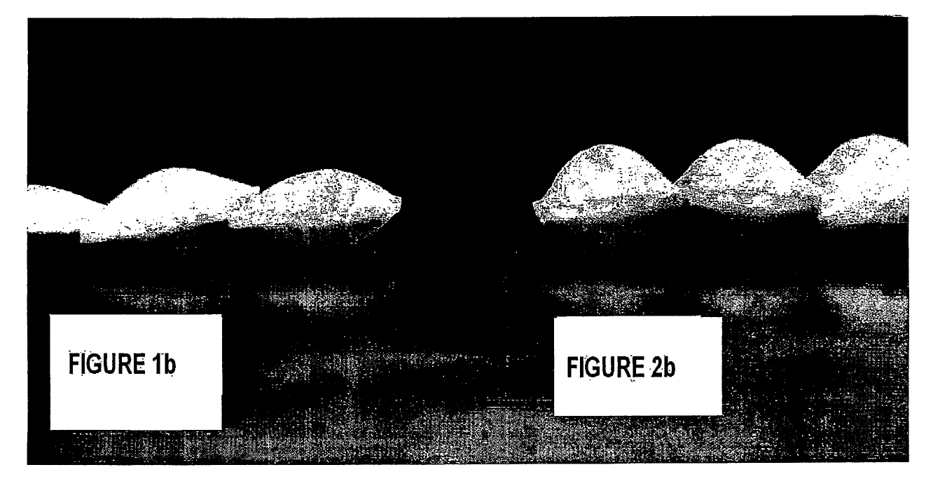

FIG. 1b is a side view of the puffed snack of FIG. 1a.

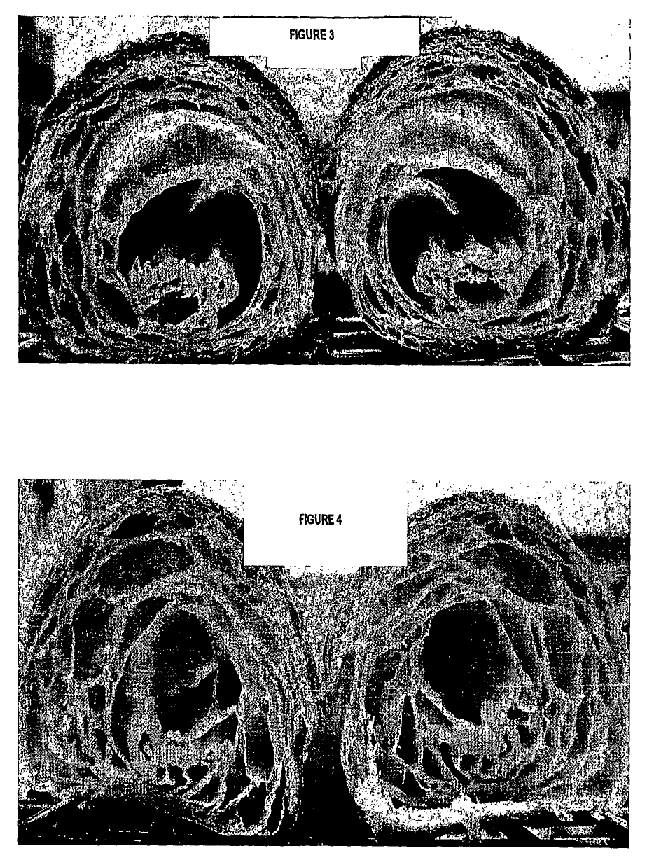

FIG. 2b is a side view of the puffed snack of FIG. 2a.

FIG. 3 is a cross-section of a croissant made from non-waxy wheat flour.

FIG. 4 is a cross-section of a croissant made from waxy wheat flour.

### DETAILED DESCRIPTION OF THE INVENTION

In the present invention waxy wheat flour refers to wheat flour with an amylose content of less than 5%, preferably 1% or less such as substantially zero.

In accordance with the broadest aspect of this invention there is provided a method for the production of food products comprising wheat, rice, corn, sorghum, mung bean, tapioca, rye flour and/or and any other flour and added fat, said method comprising substituting the flour with 0.5-100% w/w of waxy wheat flour, wherein said waxy wheat flour replaces the fat content in said food product by 20-100% w/w.

Preferably the baked food product is a bakery item such as bread, rolls, buns such as hamburger buns, cake, muffins, pizza bases, pastry such as croissants or brioche, pastry products such as pies, and tarts, puffed snacks, and ready to eat noodle snacks wherein said waxy wheat flour in said products replaces fat content.

The content of the waxy wheat flour in the food products of the present invention may differ according to end use. Waxy wheat flour content is between 0.5 and 100% flour content, more preferably from 0.5-50%, for example, 1 to 30 such as 10-30% or alternatively 1-10% flour content, or in other embodiments from 70-100% such as 75% to 95% by weight flour content.

The content of waxy flour in instant noodle snacks according to the invention is 70-100%, such as 75% to 95% by weight of waxy flour content, with a non-waxy flour, when present, preferably being hard wheat flour and/or waxy maize starch. In another embodiment, non-waxy wheat flour may be replaced with mashed potato or other starch material.

The content of waxy flour in the preparation of bread and buns, such as hamburger buns, is generally in the amount of 0.5-50% by weight of flour content, more preferably between 1-10% flour content, with the remaining flour generally being hard wheat flour.

The content of waxy wheat flour in the preparation of cakes is generally in the amount of 0.5-50% by weight of flour content such as 1 to 20%, more preferably between 10-30% with the remaining flour content generally being soft wheat flour.

The waxy wheat flour content in pastry is generally in the amount between about 0.5-50% by weight, more preferably 1-30% such as 10-30% by weight flour content, with the remaining flour content generally being hard wheat flour.

The waxy wheat flour content in the tortillas and pizza bases is generally in the amount between 0.5-50% by weight, more preferably 1-20% by weight flour content, with the remaining flour content generally being hard wheat flour.

In accordance with a f further aspect of this invention there is provided a method for the production of a food product comprising the steps of:
(a) mixing waxy wheat flour, or a blend of waxy wheat flour and wheat flour, with about 30-75 such as 40-60 parts of water to form a dough;
(b) resting the dough or batter at about 15-30° C. for about 1 minute to about 2 hours; and
(c) reducing the thickness of the dough to about 0.5 to 5 mm such as 1.5 to 3 mm, cutting said dough into a plurality of pieces and subjecting the dough to drying or steaming and/or microwaving, steaming and/or baking or steaming and/or frying; or
(d) spreading a thin layer of dough or batter onto a heated plate at about 180° C. to 220° C. for about 80-140 seconds to give an expanded wafer.

In a preferred aspect the invention provides a method for the production of a ready to consume snack food product comprising the steps of:
(a) mixing 100 parts of waxy wheat flour, or a blend of waxy wheat flour and wheat flour comprising at least 50% waxy wheat flour with 30-75 such as 40-60 parts water to form a dough;
(b) resting the dough at about 15-30° C. for about 1 minute to about 2 hours; and
(c) reducing the thickness of the dough to about 0.5-5 mm such as 1.5-3 mm, cutting the dough to a thickness between about 1.5-3 mm into a plurality of snack pieces, and contacting the snack pieces with steam for about 2-3.5 minutes and/or baking the snack pieces at 130-190° C. for about 3-9 minutes, so as to give an expanded, high gloss snack food product; or
(d) spreading a thin layer of dough onto a heated plate at about 180° C. to 220° C. for about 80-140 seconds to give an expanded wafer.

The content of waxy wheat flour in ready to consume snack foods, such as puffed snacks, is generally in the order of about 50-100% by weight flour content, more preferably 70-100% such as 75 to 95% by weight flour content with the remaining “flour” being hard wheat flour, soft wheat flour, rye flour, rice flour, tapioca flour, mashed potato or other starch material or mixtures thereof.

As mentioned above, the inventors have surprisingly found that waxy wheat flour can replace fat content in food products such as baked goods, either partially or completely, without loss of taste, eating quality, texture or appearance of food product. The inventors have found that nutritional food products of excellent eating quality and textures are found in products containing waxy wheat in place of a proportion of wheat flour.

Instant noodle snacks prepared from waxy wheat flour have been found to produce a good quality noodle with a shiny surface and very crisp texture. Normal wheat flour blended with maize starch produces a low quality product with poor appearance and crispness.

In the case of puffed snacks, products prepared from waxy wheat flour had a unique appearance such as golden shiny surface, good expansion and crisp texture.

In the case of wafers, products prepared from waxy wheat flour were crispy, had increased spread and decreased cook time.

In the case of croissants, for example, containing 30% less fat and prepared using waxy wheat flour to replace the fat, said croissants had an excellent texture and lamination as can be seen from FIG. 4. This compares very favourably to a standard croissant prepared using non-waxy wheat flour as shown in FIG. 3.

Food products may contain small amounts of salt or other flavouring components such as chicken stock or other stocks, yeast improvers, yeast, sugar and/or gluten. Other minor amounts of components may include humectants, whey powders, gums, colour at levels less than 1%, artificial flavours, baking powders and preservatives, as well as other components well known in the manufacture of food products containing flour.

Embodiments of this invention will now be described with reference to the following non-limiting examples. The quantities in the Examples below are expressed as % weight of the flour content of the formulation.

### EXAMPLE 1

Instant Noodle Snack

The materials listed in table 1 were used to prepare instant noodle snacks.

TABLE 1
Instant Noodle Snack Formulation

| Ingredient | Control | Waxy Wheat Flour Test |
|---|---|---|
| Flour | 80 | 0 |
| Waxy Wheat flour | 0 | 100 |
| Waxy Maize starch | 20 | 0 |
| Flavour | 1.0 | 1.0 |
| Na₂CO₃ | 0.2 | 0.2 |
| Water | 34 | 34 |
| Oil | 4 | 4 |

The process for preparing the instant noodle snacks was as follows:
1. Mixing the dough;
2. 1 minute dry mixing at low speed;
3. 1 minute dough mixing at low speed;
4. 1 minute dough mixing at high speed;
5. 3 minutes dough mixing at low speed;
1. Allowing the dough sheet to rest (23° C. for 30 mins);
7. Reducing the dough sheet (3 mm-2.2 mm-1.5 mm);
8. Cutting the product of step 7 with a noodle cutter (#20 cutter);
9. Steaming (100° C., 3 min); and
10. Baling (160° C., 3.5 min).

Waxy wheat flour produced a good quality instant noodle snack with a golden shiny surface and very crisp texture.

The noodles were then stored at room temperature and compared at 1, 2 and 4 months. Panelists evaluated the noodles in terms of their texture, at the two month timepoint the results of which are shown in Table 2.

The results indicate that the control noodles were generally found to be harder and dryer than noodles with waxy wheat flour. At the 2 month timepoint panelists gave the following comments. Table 2.

TABLE 2
Panelists Comments at 2 months storage

| Control | Waxy Wheat Flour |
|---|---|
| Dry, hard | Glossy, crisp, light |
| Dry, no colour, no gloss | Crisp |
| Least preferred | Crisp, glossy |
| Dry | Crisp, sticks to teeth |
| Hard, less glossy | Glossy, good colour, texture OK |

### EXAMPLE 2

Puffed Snacks

The dry ingredient blends used in the preparation of puffed snacks, contained waxy wheat flour in an amount between 70-100% by weight, with the remaining parts being instant mashed potato. The materials listed in table 3 were used to prepare puffed snacks.

TABLE 3
Puffed Snack Formulation

| Ingredient | Control | Waxy Wheat Flour Test |
|---|---|---|
| Flour | 75 | |
| Waxy Wheat flour | 0 | X |
| Instant mashed potato | 25 | 100-X |
| Flavour | 1.0 | 1.0 |
| Water | 30-75 | 30-75 |

The process for preparing the puffed snacks was as follows:
1. Mixing the dough;
2. Resting the dough sheet formed (23° C. for 30 mins);
3. Reducing the dough sheet (3 mm-2.2 mm-1.5 mm);
4. Cutting the dough sheet;
5. Steaming the product of step 4 (100° C. 3 min);
6. Drying the product of step 5 (23° C. for 24 hr); and
7. Baking the product of step 6 (180° C., 7.5 min).

The puffed snacks prepared had a unique appearance and crisp texture.

### EXAMPLE 3

Microwavable Puffed Snacks

The dry ingredient blends used in the preparation of microwavable puffed snacks, contained waxy wheat flour in an amount between 70-100% by weight, with the remaining parts being instant mashed potato.

The materials listed in table 4 were used to prepare microwavable puffed snacks.

TABLE 4
Microwavable Puffed Snack Formulation

| Ingredient | Control | Waxy Wheat Flour Test |
|---|---|---|
| Flour | 75 | 0 |
| Waxy Wheat flour | 0 | X |
| Instant mashed potato | 25 | 100-X |
| Flavour | 1.0 | 1.0 |
| Water | 30-75 | 30-75 |

The process for preparing the instant noodle snacks was as follows:
1. Mixing the dough;
2. Resting the dough sheet (23° C. for 30 mins);
3. Dough sheet reduction (3 mm-2.2 mm-1.5 mm);
4. Cutting;
5. Drying the product of step 4; and
6. Puffing the product of step 5 (approximately 20 sec at cooking level).

Microwave puffed snacks had a unique appearance and crisp texture.

### EXAMPLE 4

Wafers

The dry ingredient blends used in the preparation of wafers, contained waxy wheat flour in an amount between 50-100% by weight, with the remaining parts being normal wheat flour.

The materials listed in table 5 were used to prepare wafers.

TABLE 5
Wafer Formulation

| Ingredient | Control | Waxy Wheat Flour Test |
|---|---|---|
| Flour | 100 | 100-X |
| Waxy Wheat flour | 0 | X |
| Sodium bicarbonate | 0.5 | 0.5 |
| Salt | 0.5 | 0.5 |
| Lecithin | 0.1 | 0.1 |
| Flavour | 1.0 | 1.0 |
| Water | 30-75 | 30-75 |

The process for preparing the wafers was as follows:
1. Mixing all ingredients into batter;
2. Allowing the mixture to stand for 1 minute;
3. Spooning the batter onto hotplate; and
4. Cooking (214° C. for 100 secs turning every 20 seconds).

The following observations were made in Table 6

TABLE 6

| Observation | Control | Waxy Wheat flour Test |
|---|---|---|
| Diameter (cm) | 10-10.5 | 11-11.5 |
| Cook Time (secs) | 120 | 100 |
| Texture | Hard | Crisp |
| Bite | Some parts are soggy, | Light and crunchy |
| | some parts are crunchy | |

### EXAMPLE 5

Hamburger Bun

The materials listed in table 7 were used to prepare hamburger buns.

TABLE 7
Hamburger Bun Formulation

| Ingredient | Control | Waxy wheat flour |
|---|---|---|
| Flour | 100 | 100-X |
| Salt | 1.5-2.5 | 1.5-2.5 |
| Water | 50-75 | 50-75 |
| Improver | 0-5 | 0-5 |
| Yeast | As required | As required |
| Gluten | 0-8 | 0-8 |
| Sugar | 5-15 | 5-15 |
| Soya flour | 0-2 | 0-2 |
| Fat/Oil | 2-12 | 1-9.6 |
| Waxy Wheat flour | 0 | X |
| Fibre | 0 | 0-8 |

The process for preparing the hamburger buns was as follows:
1. Mixing low speed 2 minutes, high speed 8 minutes;
2. Increasing final dough temperature 28-32° C.;
3. Intermediate proof (3 minutes);
4. Make up (Scale 50-120 g, Sheet 6-12 mm);
5. Final proof (38° C., RH 85%, 30-120 minutes); and
6. Bake (180-210° C., 10-20 minutes).

Crumb softness and elasticity of both hamburger buns (control and waxy one) were analysed with Texture Analyzer. The results can be seen in Table 8.

TABLE 8
Comparison in crumb softness and elasticity of hamburger buns
after 3 days storage (control and waxy wheat flour)

| Analysis | Control | Waxy wheat flour |
|---|---|---|
| Softness (Newton) | 9.59 | 6.75 |
| Elasticity (%) | 48.6 | 50.8 |

In sensory tests, both hamburger buns were very similar.

The amount of added fat required for an excellent taste, texture and quality bun was significantly reduced.

### EXAMPLE 6

Cakes

The flour blends used in the preparation of cakes, blends contained waxy wheat flour in an amount between 0.5-50% by weight, more preferably between 1-20% with the remaining parts being soft wheat flour.

The materials listed in table 9 were used to prepare cakes.

TABLE 9
Madeira Cake Formulation

| | | Waxy Wheat |
|---|---|---|
| Ingredient | Control (%) | Flour Test (%) |
| Sugar | 24 | 24 |
| Fat | 12 | 5-10 |
| Humectant | 4-6 | 4-6 |
| Emulsifier | 1 | 1 |
| Salt | 0.5-1 | 0.5-1 |
| Whey Powder | 1.5-2 | 1.5-2 |
| Gum | 0.03 | 0.03 |
| Water | 1-2 | 1.61-2 |
| Colour (1%) | 0.05 | 0.05 |
| Flavour | 0.01 | 0.01 |
| Egg Pulp | 10-12 | 10-12 |
| Flour | 23-25 | 23-25 |
| Baking Powder | 0.6 | 0.6 |
| Preservative | 1.5-2 | 1.5-2 |
| Wheat Starch | 0.03 | 0.03 |
| Waxy Wheat Flour | 0 | X |

Process for preparing the Madeira cake was as follows:
1. Blend all dry ingredients;
2. Mix with wet ingredients on slow speed for 2 minutes;
3. Beat on high speed 6 minutes to obtain uniform batter of SG 1.3-1.6; and
4. Place the batter in a cake pan and baked at 160° C. for 105 minutes.

The cake was then stored at 3-4° C. and at room temperature and compared at the following timepoints 1, 2 and 5 weeks. Panelists evaluated the cake in terms of its texture. The results were that control cakes were generally found to be firmer and dryer than cakes with waxy wheat flour. At the 2 weeks timepoint panelists gave the following comments, shown in Table 10.

TABLE 10
Panelists Comments after 2 weeks storage

| Control | Waxy Wheat Flour |
|---|---|
| Dry | Fresher softer eating |
| Dry | More moist |
| Least preferred | Really moist |
| Dry | Gluier |
| Drier - sugar crystals | Prefer, less dry |
| | Not much difference |

### EXAMPLE 7

Pastry

The flour blends used in the preparation of pastry contained waxy wheat flour in an amount between 0.5-50% by weight, more preferably between 1-30% with the remaining parts being hard wheat flour.

The materials listed in Table 11 were used to prepare pastry.

TABLE 11
Puff Pastry Formulation

| Ingredient | Control | Waxy Wheat Flour |
|---|---|---|
| Hard wheat Flour | 100 | 100-X |
| Salt | 1 | 1 |
| Water | 47.5 | 48.8 |
| Waxy Flour | 0 | X |
| Margarine | 50 | 30-50 |

The process for preparing the pastry was as follows:
1. Mix flour salt and water to form dough the same consistency as margarine;
2. Mix 4 minutes slow, 2 minutes fast;
3. Allow dough to rest 20 minutes;
4. Flatten out dough, place margarine evenly on top;
5. Fold the two halves of the dough together;
6. 10 minute rest;
7. Repeat step 5;
8. 5 minute rest;
9. Roll out;
10. Cut into match squares; and
11. Bake at 220° C. for 13 minutes.

The process for preparing the pastry was the same regardless of the formulation.

The product was then evaluated in terms of lift and expansion with the following results shown in Table 12.

TABLE 12
Final Product Quality

| Quality Indicator | Control | Waxy Wheat Flour |
|---|---|---|
| Sheets unbaked (cm) | 12.4 * 6.0 | 12.4 * 6.0 |
| Sheets baked (cm) | 11.2 * 4.6 | 11.2 * 4.6 |
| Height (mm) | 14 | 21 |

Pastry using waxy wheat flour showed good lift and expansion compared to the control, which can be seen from Table 12 in the values given for the height of each product.

### EXAMPLE 8

Croissant

The flour blends used in the preparation of croissants contained waxy wheat flour in an amount between 1 and 30% more preferably 20 to 30% by weight.

The materials listed in Table 13 were used to prepare the croissant.

TABLE 13
Croissant Formulation

| Ingredients | Control | Waxy wheat |
|---|---|---|
| Flour | 100 | 80 |
| Milk | 55-60 | 55-60 |
| Butter | 10-30 | 10 |
| Yeast | 3-4 | 3-4 |
| Sugar | 3-4 | 3-4 |
| Salt | 2-3 | 2-3 |
| Waxy wheat | 0 | 20-30 |
| Crusty improver | 0 | 1-1.5 |
| Margarine | 55-60 | 25-30 |

The process for preparing the croissant was as follows:
1. Combine yeast with the milk and dissolve. Form a dough with flour, sugar, salt and improver. Pin dough out and add remaining components. Give 3 half turns and allow to rest for 10-30 mins in fridge. Give another 3 half turns and allow to rest again. Give 3 more half turns and rest overnight.
2. Pin out to desired shape
3. Proove for 35-45 minutes. Egg wash and bake for 18 minutes at 210 degree C.

Sensory results indicated croissant with waxy wheat flour was acceptable in terms of taste and texture. The internal appearance of croissant with waxy wheat flour was better in terms of product lamination. Control croissant had dark crust with open and airy structure whilst croissant with waxy wheat flour gave more desirable brown color on the crust with good lamination as shown in FIG. 1 attached.

### EXAMPLE 9

Part Baked Pizza Base.

The flour blends used I the preparation of pizza bases contained waxy wheat flours in an amount between 1 to 10% preferably 5%.

The material listed in Table 14 were used in the preparation of the pizza bases.

TABLE 14
Part Baked pizza base Formulation

| Ingredient (%) | Control | Waxy wheat flour |
|---|---|---|
| Flour | 100 | 95 |
| Water | 60 | 60 |
| Fat | 10 | 7.5 |
| Improver | 5 | 5 |
| Waxy Wheat Flour | 0 | 5 |

The process for preparing the pizza bases was as follows:
1. Mix all ingredients;
2. Scale at 225-270 g;
3. Rest for 25 minutes;
4. Press into desired shape; and
5. Bake at 190° C. for 3 minutes.

Pizza bases using waxy wheat flour had similar sensory characteristics to control and their fresh keeping quality was improved.

### EXAMPLE 10

Chinese Buns (Mantou)

The flour blends used in the preparation of the Chinese buns contained waxy wheat flour in an amount between 1 and 30% preferably 10 to 30% by weight.

The materials listed in table 15 were used to prepare said Chinese buns.

TABLE 15
Mantou Formulation

| Ingredient | Control Formulation | Waxy Wheat Flour Formulation |
|---|---|---|
| Hard wheat Flour | 100 | 100-X |
| Sugar | 10 | 10 |
| Margarine | 25 | 10 |
| Yeast | As required | As required |
| Waxy Flour | 0 | X (10-30) |
| Coco powder | 10 | 10 |

The process for preparing the Chinese buns was as follows:
1. Mix sugar, warm water and yeast. Leave for 10 minutes until foaming;
2. Add flour and margarine and knead until soft and elastic, take ¼ part of the dough a and mix with coco powder to form choco dough;
3. Cover the dough and allow to rest in a warm place for 2 hours or until dough has doubled in bulk. Knead a few times during this 2-hour period. Knead again before using;
4. Separate plain and choco dough into loaves or form into buns of desired size;
5. Put the choco dough in the middle of plain dough and form a small loaf and steam until done ie 4 minutes slow, 2 minutes fast.

The Chinese buns with prepared waxy wheat flour were not significantly different in terms of sensory properties if compared to control but had 40% less margarine.

### EXAMPLE 11

Wheat Based Sheets To Make Savoury Cake (Malay/Indian Style )

The flour blends used in the preparation of the sheets contained waxy wheat in an amount between 30 and 50% by weight.

The materials listed in Table 16 were used to prepare wheat based sheet

TABLE 16
Wheat Based Sheets to Make Asian Snacks Formulation

| Ingredient | Control | Waxy Wheat Flour |
|---|---|---|
| Hard Wheat Flour | 100 | 100-X |
| Salt | 10 | 10 |
| Cooking oil | 30 | 15 |
| Waxy Flour | 0 | X (30-50) |
| Water | 40 | 20 |

The process for the preparation of the sheets was as follows:
1. Mix flour and water to make dough, which was kneaded until soft and elastic;
2. Addition of oil little by little while kneading the dough until all oil was added, rest for 2 hours; and
3 Separate the dough into 10 pieces and make thin sheet.

The sheets made from waxy wheat flour was very extensible and was not as oily as the control.

### EXAMPLE 12

Low Glycemic Index (GI) American Style Muffin

The materials listed in Table 17 were used to prepare low GI American style muffin

TABLE 17
Low GI American style muffin formulation

| Ingredient | Control muffin | Low GI Trial |
|---|---|---|
| Sugar | 20-30% | 20-30% |
| Soft wheat flour | 20-22% | 28-29% |
| Modified starch | 2-3% | 1-1.5% |
| Whey Powder | 1-1.5% | 1.5-2% |
| Salt | 0.5-1% | 0.0% |
| Sodium Bicarbonate | 0.3-0.5% | 0.5-1% |
| Sodium aluminium | 0.3-0.5% | 0.0% |
| phosphate | | |
| Emulsifier | 0.2-0.4% | 1.0-1.5% |
| Phospate | 0.1-0.2% | 0.1-0.2% |
| Guargum | 0.1-0.2% | 0.0% |
| Dextrose | 0.5-0.7% | 0.0% |
| Egg | 15-20% | 8-15% |
| Oil | 13-16% | 0.0% |
| Water | 13-15% | 20-23% |
| Waxy wheat flour | 0.0% | 0.5-1% |
| Inulin | 0.0% | 8-9% |
| Sodium Acid pyrophosphate | 0.0% | 0.5-1% |
| Egg Albumen | 0.0% | 1.5-2% |
| Glycerine | 0.0% | 6-7% |

The process for making said muffin was as follows:
1. Mix all ingredients except oil on low speed for 1 minute, follow then scraping
5 down, the ingredients from the side of the mixing container;
2. Mix for 3 minutes on medium speed;
3. Add in the oil followed by blending at low speed for 2 minutes;
4. Distributing 100 g portions of the mix into a muffin tray lined with paper cups; and
5. Baking the product of step 4 at 200° C.

It was found that the muffins containing waxy wheat flour had a soft and moist eating texture. They also had an increase volume compared to the control and met the guidelines for low GI products, whilst simultaneously maintaining good eating quality

Throughout this specification and the claims which follow, unless the context requires otherwise, the word “comprise”, or variations such as “comprises” or “comprising”, will be understood to imply the inclusion of a stated integer or step or group of integers or steps but not the exclusion of any other integer or step or group of integers or steps.

The reference to any prior art in this specification is not, and should not be taken as an acknowledgment or any form of suggestion that that prior art forms part of the common general knowledge in Australia.

1. A method for the production of food products comprising wheat, rice, corn, sorghum, mung bean, tapioca, soya, rye flour and/or and any other flour and added fat, said method comprising substituting the flour with 0.5-100% w/w of waxy wheat flour, wherein said waxy wheat flour replaces fat content in said food product by 20-100% w/w.

2. A method according to claim 1, wherein the food product comprises wheat and/or rye flour.

3. A method according to claim 1 wherein said food products are selected from bread, rolls, pizza bases, tortillas, spring roll pastry, buns such as hamburger buns, cake, pastry such as croissants, brioche or Chinese buns, pastry products such as pies, and tarts, puffed snacks, and noodles particularly ready to eat noodle snacks, biscuits and wafers wherein waxy wheat flour in said products replaces fat content.

4. A method according to claim 3 wherein said food products are selected from bread, rolls, buns such as hamburger buns, cake, pastry such as croissants or brioche, pastry products such as pies, and tarts, puffed snacks, and ready to eat noodle snacks wherein waxy wheat flour in said products replaces fat content.

5. A method according to claim 1 which is a method for the production of noodles such as an instant noodle snack food product wherein 70-100% of flour content is waxy wheat flour.

6. A method according to claim 1 which is a method for the production of bread and buns, such as hamburger buns, wherein 0.5-50% of flour content is waxy wheat flour.

7. A method according to claim 1 which is a method for the production of a pastry food product wherein 0.5-50% of flour content is replaced with waxy wheat flour.

8. A method for the production of a food product comprising the steps of:
(a) mixing waxy wheat flour, or a blend of waxy wheat flour and wheat flour, with 30-75 parts of water to form a dough;
(b) resting the dough or batter at 15-30° C. for 1 minute to 2 hours; and
(c) reducing the thickness of the dough to 0.5 to 5 mm such as 1.5 to 3 mm, cutting said dough into a plurality of pieces and subjecting the dough to extrusion or steaming and/or microwaving, steaming and/or baking or steaming and/or frying; or
(d) spreading a thin layer of dough or batter onto a heated plate at 180° C. to 220° C. for 80-140 seconds to give an expanded wafer.

9. A method according to claim 8 for the production of a ready to consume snack food product comprising the steps of:
(a) mixing 100 parts of waxy wheat flour, or a blend of waxy wheat flour and wheat flour comprising at least 50% waxy wheat flour, with 30-75 parts water to form a dough;
(b) resting the dough at 15-30° C. for 1 minute to about 2 hours; and
(c) reducing the thickness of the dough to about 0.5-5 mm such as 1.5-3 mm, cutting the dough to a thickness between about 1.5-3 mm into a plurality of snack pieces, and contacting the snack pieces with steam for about 2-3.5 minutes and/or baking the snack pieces at 130-190° C. for about 3-9 minutes, so as to give an expanded, high gloss snack food product; or
(d) spreading a thin layer of dough onto a heated plate at 180° C. to 220° C. for 80-140 seconds to give an expanded wafer.

10. A product obtainable by the method defined in claim 1, wherein said product has a reduced fat content in comparison to corresponding products not made by said method without loss of taste or eating quality texture.

11. A product according to claim 10, wherein the product is a hamburger bun.

12. A product according to claim 11, wherein the hamburger bun has reduced sugar content in comparison to hamburger buns not made by said method.

13. A product according to claim 12, wherein the sugar content is reduced by 50%.

14. (canceled)

15. (canceled)

16. (canceled)

17. (canceled)

18. (canceled)

19. (canceled)

20. (canceled)

21. (canceled)

22. (canceled)

23. (canceled)

24. A hamburger bun comprising 0.5 to 50% by weight of waxy wheat flour, wherein the waxy wheat replaces between 20 and 100% of the fat content of the bun.

25. A hamburger bun according to claim 24, wherein the waxy wheat content in the range 1 to 10% by weight.

26. A hamburger according to claim 25, with a reduced sugar content in comparison to hamburger buns prepared from non-waxy wheat.

27. A hamburger according to claim 26, wherein the sugar contents is reduced by up to 50%.

28. A croissant comprising 0.5 to 50% by weight of waxy wheat flour, wherein the waxy wheat replaces between 20 and 100% of the fat content of the bun.

29. A croissant according to claim 28, wherein 30% of the fat is replaced.

30. A croissant according to claim 29, wherein the waxy wheat content is in the range 20 to 30% by weight.
